(19) United States
(12) Patent Application Publication
(10) Pub. No.: US 2004/0032739 A1
(43) Pub. Date: Feb. 19, 2004

(54) Illumination tubes, illumination devices and methods of forming same

(76) Inventor: Walter A. Johanson, St. Paul, MN (US)

Correspondence Address: DANIEL P. BURKE, ESQ., GALGANO & BURKE, Suite 135, 300 Rabro Drive, Hauppauge, NY, 11788, US

(21) Appl. No.: 10/223,153

(22) Filed: Aug. 15, 2002

(51) Int. Cl. F21V 7/00

(52) U.S. Cl. 362/304; 362/297; 362/551; 362/346

(57) ABSTRACT

Embodiment of the present invention comprise novel reflectors for directing more light parallel to the longitudinal axis of an illumination tube. Other embodiments are directed to devices for supporting illumination tubes. Other aspects are directed to coated substrates which provide better light distribution from illumination tubes. Other aspects of the present invention provides improved light distribution systems designed to provide protection from ultra-violet rays emanating from the light source(s) used in an illumination tube.

Various embodiments of the present inventions are directed to illumination tubes, components therefor and methods of making such systems.

### BACKGROUND OF THE INVENTION

Various forms of light distribution systems including light tubes utilizing optical light film such as those disclosed in Applicant's U.S. Pat. No. 6,169,839 which issued on Jan. 2, 2001 and light distributing tubes such as those disclosed in Applicant's U.S. Pat. No. 6,014,489 which issued on Jan. 11, 2000 have been previously disclosed. Such devices have utilized artificial light sources, typically with a parabolic reflector, and in some instances with a modified parabolic reflector. Such illumination devices have also been disclosed which are formed from generally planar sheets which can be stored and shipped to their ultimate destination in a flat configuration to save space and then be assembled into hollow tubes prior to use. Such tubes and newer tubes with fewer layers having greater light output, while sufficient to hold their own weight could benefit and could be easier to handle if provided with greater rigidity and strength.

Therefore, it would be desirable to provide illumination tubes and illumination devices for use with such tubes and methods of forming such illumination tubes and devices with added rigidity and strength. It is also desirable to increase the efficiency of previously disclosed illumination tubes.

### SUMMARY OF THE INVENTION

Various embodiments of the present invention are directed to devices for supporting illumination tubes. The disclosed devices facilitate supporting and connection segments of illumination tubes, for example light distributor tubes.

Other aspects of the present invention are directed to coated substrates which provide better light distribution from illumination tubes. Other aspects of the present invention provides improved light distribution systems designed to provide protection from ultra-violet rays emanating from the light source(s) used in an illumination tube.

Still another embodiment of the present invention comprise novel reflectors for directing more light parallel to the longitudinal axis of an illumination tube.

### BRIEF DESCRIPTION OF THE DRAWINGS

FIG. 1 is a cross-sectional view of a conventional parabolic reflector.

FIG. 2 is a cross-sectional view of a conventional parabolic reflector illustrating the angular range of reflectance.

FIG. 3 illustrates one source of artificial light used with the present invention.

FIG. 4 is a graphic display of the intensity of light distributed from the artificial light source shown in FIG. 3.

FIG. 5 illustrates a reflector device of one embodiment of the present invention.

FIG. 6 illustrates a reflector device of an alternative embodiment of the present invention.

FIG. 7 illustrates a reflector device of a still further embodiment of the present invention.

FIG. 8 is an exploded view of an illumination tube and support assembly in an unassembled configuration.

FIG. 9 illustrates an alternative illumination tube and support assembly which is unassembled and which utilizes an optical light film.

FIG. 10 is a cross-sectional view of an illumination tube and support assembly shown in the assembled form with portions of the light distributor tube not shown.

FIG. 11 is a cross-sectional side view of a proximal portion of a light distributor tube and a portion of a support assembly with a lamp.

FIG. 12 is a top view of the elements shown in FIG. 11.

FIG. 13 is a top view of the distal end of a light distributor and support assembly of one embodiment of the present invention.

FIG. 14 is a side view of an illumination tube with a support assembly and lamp of one embodiment of the present invention.

FIGS. 15 and 16 are unassembled and assembled cross-sectional and side views, respectively, of adjacent sections of an illumination tube of one embodiment of the present invention.

FIG. 17 is an assembled top view of the illumination tube shown in FIG. 16.

FIG. 18 is a cross-sectional end view of a distributor tube and support of one embodiment of the present invention.

FIG. 19 is an end view of a support sub-assembly.

FIG. 20 is an exploded view of an illumination tube support assembly comprising a relatively movable support and bracket assembly.

FIG. 21 is a schematic diagram illustrating the site of light meter readings discussed below.

### DETAILED DESCRIPTION

The various aspects of the present invention are directed to illumination tubes and devices for use with illumination tubes. As used herein the term “illumination tube” indicates a device comprising a surface, which is remote from a source of illumination, which reflects light for area illumination. As used herein, the term “illumination tube”, includes light tubes incorporating optical light film (commonly referred to as hollow light guides) as well as light distributor tubes which comprise a surface for deflecting light from a remote source of illumination. As described in greater detail below, some aspects of the present invention can be utilized with both natural and artificial light while other aspects to the present invention are designed specifically for use with sources of artificial light. While the illustrated illumination tubes are circular, the illumination tubes of the present invention and useful with various aspects of the present invention are not necessarily circular in cross-section.

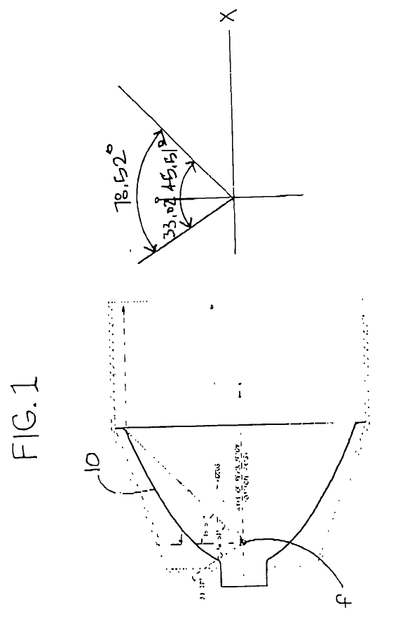

FIG. 1 is a cross sectional view of a previously used parabolic reflector having a focal length of 0.5 inches and a focal point f. FIG. 1 illustrates that if the arc of a lamp is positioned at focal point f, this parabolic reflector will reflect light from that arc out the distal end of the parabolic reflector 10. The illustrated reflector 10 reflects light leaving focal point f and traveling proximally, at an angle of up to about 33° from the illustrated vertical axis passing through focal point f, and the light travelling distally from the vertical axis for about 45.5° for a total angle of about 78.5°. As indicated, the light reflected off parabolic reflector 10 will travel substantially parallel to the axis of revolution x.

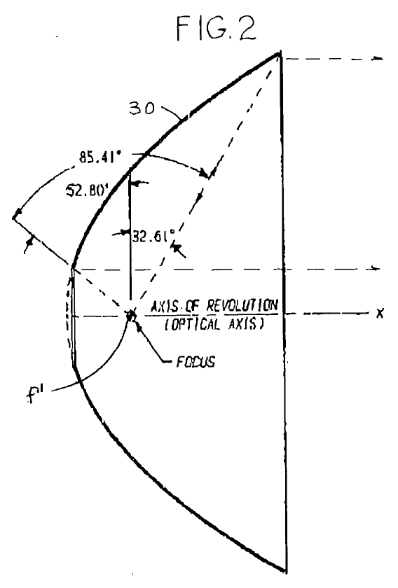

FIG. 2 is a cross-sectional view of another previously known parabolic reflector having a focal length f′. This reflector reflects light through an angle of about 52.8° rearwardly of a vertical axis passing through the focal point f′ and 32.61° forwardly out of the vertical axis for a total angular span of 85.41°

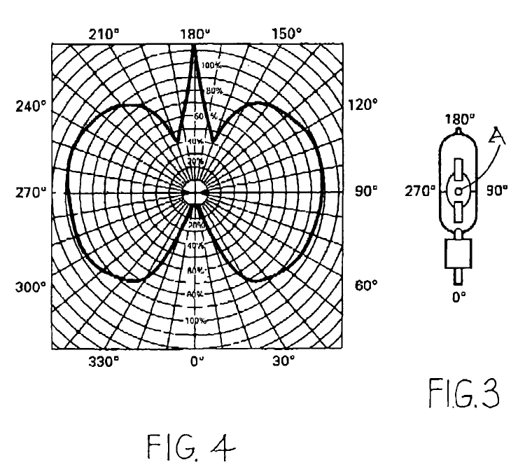

FIG. 3 is a schematic representation of an artificial light source, e.g. a Philips 700-watt MSD metal halide lamp which may be utilized with the present invention. This type of artificial light source is particularly suitable since it has a relatively short arc, e.g. a 10 mm arc length, which is readily positionable at a focal point.

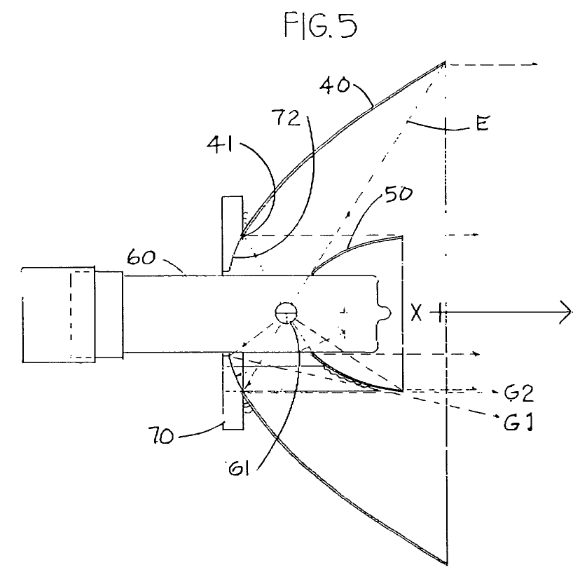

FIG. 4 is a schematic representation of the intensity of artificial light emanating from the artificial light source shown in FIG. 3. The dark lines on the graph indicate the intensity of the beam at various angles relative to the orientation of the light source. The angles on the graph in FIG. 4 correspond to the indications of 0°, 90°, 180° and 270° shown on FIG. 3. As indicated on the graph in FIG. 4, most of the artificial light leaving this artificial light source is directed between 25° and 155°, and between 205° and 335°. If the arc of the light source, which is represented by the small circle A in the center of the lamp, is placed at the focal point of a parabolic reflector having a focal length of 1.3 inches and the parabola is designed to be connected with a tube having a diameter of 10 inches, then the portion of the light between 135° and 155° and between 205° and 225° would not hit the reflective surface of the parabolic reflector and, therefore, would not be collimated prior to entry into an illumination tube. Since some illumination tubes, particularly the distributor tubes discussed in the above-referenced patent, operate most efficiently when receiving collimated light, it is desirable to collimate the maximum amount of light possible.

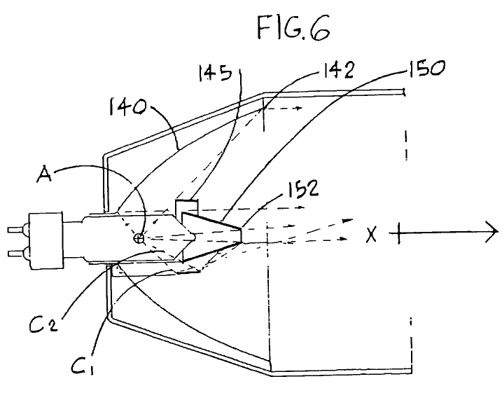

FIG. 5 illustrates a modified parabolic reflector designed for use with an artificial light source such as that represented in FIG. 3. In this embodiment of the present invention, both a first parabolic reflector 40 having a first focal length and a second parabolic reflector 50 having a second focal length are positioned with their focal points located-substantially on a common source of illumination, e.g. the arc of a lamp. The focal points of the two parabolic reflectors are ideally coincident, and are preferably spaced by a distance no greater than one-half of the arc length of the source of artificial illumination. In this illustrated embodiment, the focal length of second parabolic reflector 50 is less than the focal length of parabolic reflector 40. Also, it is most preferable if the reflectors are positioned such that their focal points are coincident. In this illustrated embodiment, lamp 60 comprises an arc 61 which most preferably is positioned on, or less preferably very close to, the focal points of the larger parabolic reflector 40 and smaller parabolic reflector 50. As illustrated by line E, parabolic reflector 50 is designed to reflect light emanating from arc 61 which would not otherwise contact parabolic reflector 40. Parabolic reflector 50 reflects additional light into an illumination tube. In this illustrated preferred embodiment, the light reflected by second parabolic reflector 50 is preferably substantially coaxial with light reflected by first parabolic reflector 40.

Though not shown, it is also within the scope of the present invention to change the relative positions of the first and second parabolic reflectors. For example, second parabolic reflector 50 could be positioned to reflect light that would otherwise contact the first parabolic reflector 40. This, of course, would result in some loss of efficiency in the system. Moreover, when it is desired to provide a substantially collimated beam of light to the illumination device, it is most preferable that the first parabolic reflector 40 and second parabolic reflector 50 both be positioned with the source of illumination located at their focal points.

The proximal end 41 of first parabolic reflector 40 is preferably positioned relative to the second parabolic reflector 50 so that light striking the proximal end 41 of the first parabolic reflector 40 directly from arc 61 will be reflected in a direction which does not strike the exterior surface of the second parabolic reflector 50, and most preferably in a direction parallel to the longitudinal axis x.

It is also desirable to reflect light emanating from arc 61 and initially traveling at an angle from the vertical axis which is greater than the angle which would strike the proximal end 41 of first reflector 40, in a direction which does not strike the rear exterior surface of second parabolic reflector 50. Therefore, a third reflective surface 72 is provided on a base plate 70. Reflective surface 72 of base plate 70 is advantageously designed to reflect light emanating from arc 61 in a direction which causes the reflected light to avoid passing through lamp 60 and to avoid striking rear surface of second parabolic reflector 50. Light reflected by the proximal and distal ends of reflective surface 72 are indicated by arrows G₁ and G₂ in FIG. 5. Though the rays of light indicated by arrows G₁ and G₂ will not be perfectly parallel to longitudinal axis x, light directed in these directions is directed into the illumination tube, reflected into the desired illumination area and is, therefore, not wasted.

From the present description, those skilled in the art will appreciate that parabolic reflectors having different focal lengths can be utilized and that the reflective surface, indicated as surface 72 in this illustrated embodiment, can be modified without the departing from the scope of the present invention.

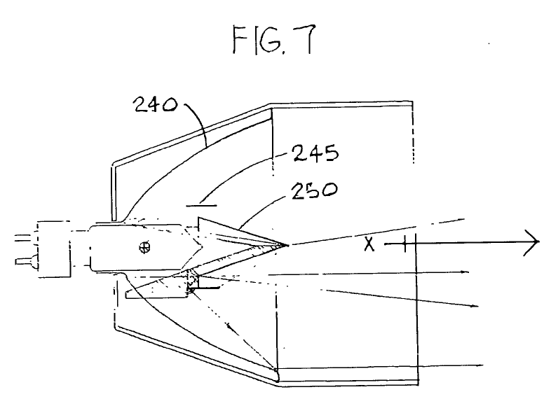

FIG. 6 illustrates an alternative modified reflector of the present invention. This embodiment comprises a first parabolic reflector 140, a second reflector 145 and a truncated conical reflector 150. The reflector system illustrated in FIG. 6 is also designed to reflect light into an illumination tube which would otherwise pass beyond the distal end 142 of parabolic reflector 140. According to this illustrated embodiment of the present invention, light which would otherwise extend beyond the distal end 142 of first parabolic reflector 140 is reflected off the interior reflective surface of second reflector 145 and onto the exterior reflective surface of truncated conical reflector 150. Lines C₁ and C₂ indicate light emanating from illumination point A which strike second reflector 145 and are reflected onto the exterior reflective surface of truncated conical 150 which then reflects this light distally and substantially parallel to the longitudinal axis x of the illumination tube (not shown). The distal end 152 of conical reflector 150 is desirably truncated in this illustrated embodiment in order to allow light emanating relatively close to longitudinal axis x directly from lamp arc A to the illumination tube.

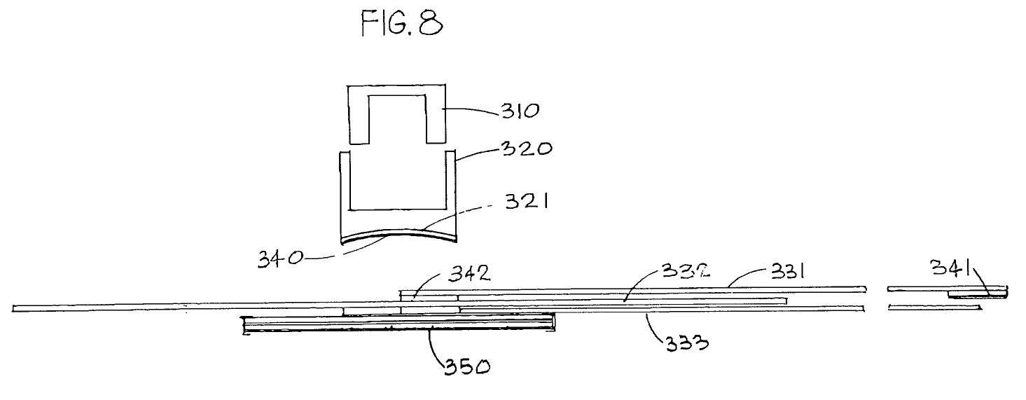

FIG. 7 illustrates a still further embodiment of a modified parabolic reflector of the present invention. According to this illustrated embodiment, the distal end of conical reflector 250 is not truncated but terminates in a closed conical surface. This modified parabolic reflector is otherwise similar to the modified reflector shown in FIG. 6. By extending the distal end of conical reflector 250 more distally, a greater amount of light can be reflected parallel to longitudinal axis x of the illumination tube.

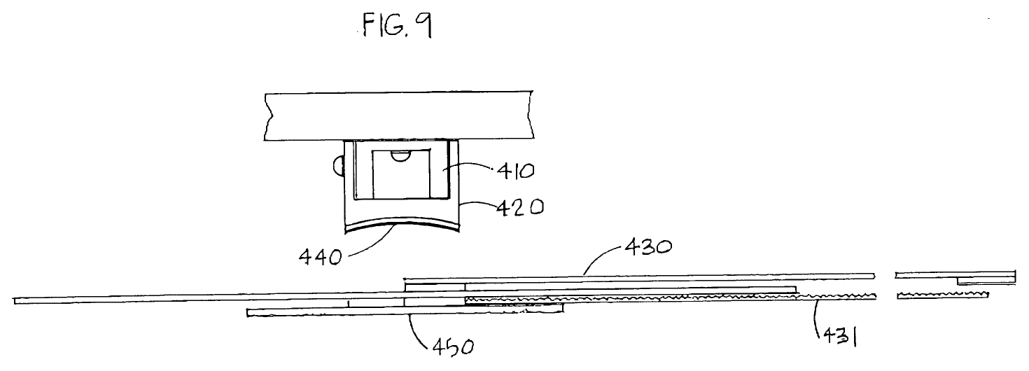

FIGS. 8-20 are directed to other aspects of the present invention which can provide a unified system of parts which enable a illumination tube to be supported and made more rigid. These aspects of the present invention can also protect and help secure seams of illumination tubes which are formed from one or more sheets. Those skilled in the art and familiar with the inventor's prior inventions will appreciate that it is particularly desirable to store and ship unassembled illumination tubes in a relatively flat configuration prior to assembly. When such tubes are assembled, they will have at least one longitudinal seam and, when a plurality of segments are placed together, a plurality of circumferential seams. The aspects of the present invention illustrated in FIGS. 8-20 provide additional support to such tubes and also help protect and secure the seams. These illustrated aspects of the present invention are also designed to facilitate hanging or otherwise supporting an illumination tube, to facilitate the connection of tube segments as well as to connect a tube or a tube segment to a source of illumination.

The embodiment of the present invention illustrated in FIG. 8 comprises a bracket 310 and a support 320. Bracket 310 is preferably extruded from a rigid material such as a metal, e.g., aluminum, plastic, or other suitable material. Bracket 310 can be any desired length or width. One suitable length is approximately six inches long wherein a plurality of such brackets provides sufficient support as described in further detail below.

Support 320 is also preferably formed using a substantially rigid material, such as a metal, e.g., aluminum, or a rigid plastic which can readily be extruded. Support 320, when intended for use with a substantially round illumination tube as in this illustrated embodiment, most preferably has a curve support surface 321 which follows the curved contour of the illumination tube. While different sizes can be utilized without the departing from the scope of the present invention, it is most preferred that a single support 320 or, alternatively, a plurality of supports 320 collectively extend for at least a major portion of the longitudinal length of an illumination tube. If a plurality of supports are utilized, they can be connected. Most preferably, a single support 320 extends substantially the full length of an illumination tube.

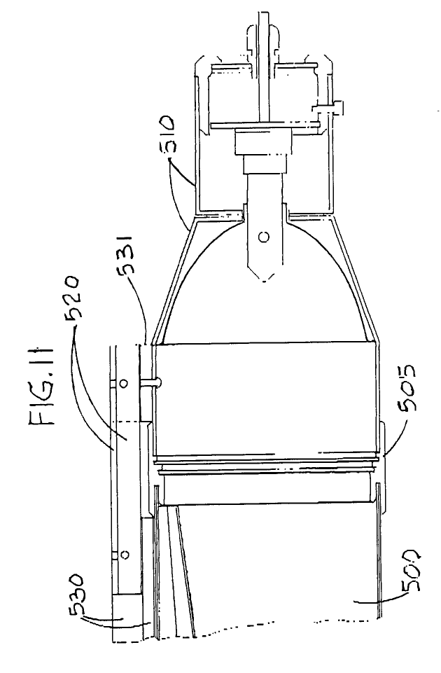

In this illustrated embodiments of FIGS. 8 and 10, the illumination tube comprises a polished/matte film 331, preferably a film available from the General Electric Company known as a Lexan film having one polished surface and one matte surface. The polished surface comprises a coating which advantageously protects the film from ultra violet light emanating from a light source, whether natural or artificial, and also protects the tube from abrasion. Film 332 is preferably a film having a non-smooth surface such as GE Lexan suede/matte film. Film 333 is preferably the same type of film as 331, however, the coated polished surface of film 333 is preferably disposed on the interior side (the bottom in FIG. 8) while the coated polished side of film 331 is disposed on the exterior of the illumination tube. This illustrated illuminator tube also comprises a light redirecting surface 350 which advantageously comprises a reflective coating coated onto a non-smooth substrate as GE Lexan suede matte film.

The exterior surface of film 331 is preferably connected to support 320 utilizing a double-sided adhesive tape 340 which advantageously extends longitudinally between support 320 and the outer surface of film 331. Film 331 is also advantageously connected to sheet 332 utilizing sections of tape 341 and 342. FIG. 10 illustrates a similar embodiment of the present invention, showing the upper half of the illumination tube and the light redirecting surface 350 assembled. This embodiment also comprises a rigid outer tube. The non-smooth substrate 352 is coated with a reflective coating 351 which can be a reflective coating such as B70-339 “STAR BRIGHT WHITE” available from the Spraylat Corporation of Mount Vernon, N.Y. This coating is a reflective coating comprises about 38% solids preferably is applied by spraying to a recommended minimum film thickness of 2 mils when dry.

As shown in the assembled view of FIG. 10, bracket 310 is readily connected to support 320 with a bolt 311 and can be readily be suspended from a ceiling using a hanger 312.

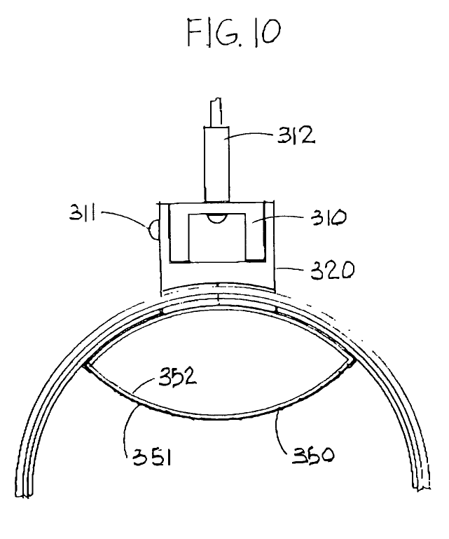

FIG. 9 illustrates an alternative embodiment of the present invention wherein an illumination tube comprising an outer sheet 430, an optical light film 431 and a light redirecting surface 450 are connected to each other and a support 420 utilizing an adhesive tape 440. The light redirecting surface 450 can be formed with a coated non-smooth substrate in a manner similar to light redirecting surface 350 of the embodiment illustrated in FIGS. 8 and 10. According to this embodiment, the bracket 410 is connected directly to a rigid structure such as a ceiling, wall, post or other structure in the area to be illuminated.

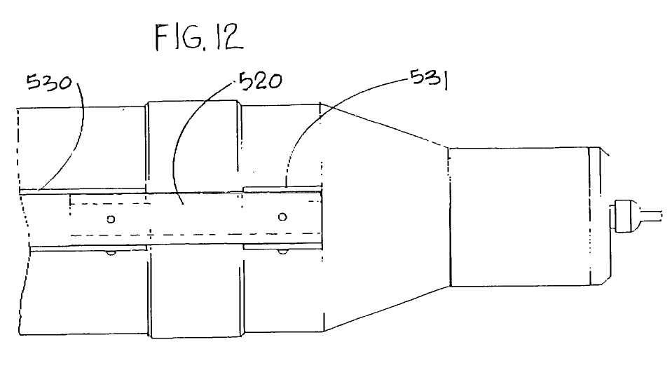

FIG. 11 is a cross-sectional side view of a proximal end of an illumination tube 500 connected to an illuminator housing 510 utilizing a bracket 520 and rigid supports 530 and 531. A ring 505, which is preferably formed of a silicon type material, is positioned between the distal end of the illuminator housing 510 for insulation purposes and to support light lenses and/or filters. In this illustrated embodiment, bracket 520 is advantageously formed to extend over a portion of ring 505 while otherwise connecting the exterior surface of illuminator housing 510 and illumination tube 500. In this illustrated embodiment, support 530 is preferably substantially rigid and, therefore, provides support and protection to the connection between the source of illumination and the illumination tube.

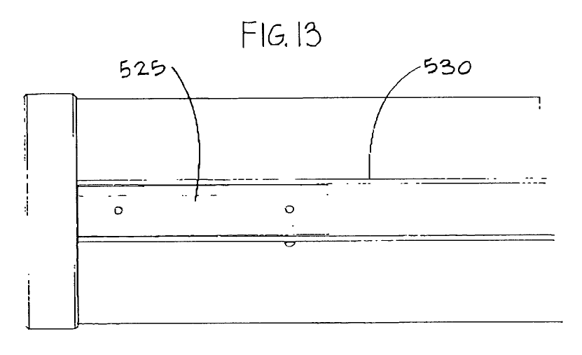

FIG. 12 is a top view of the portion of the illumination system shown in FIG. 11.

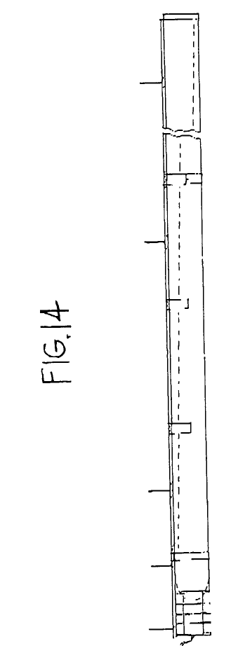

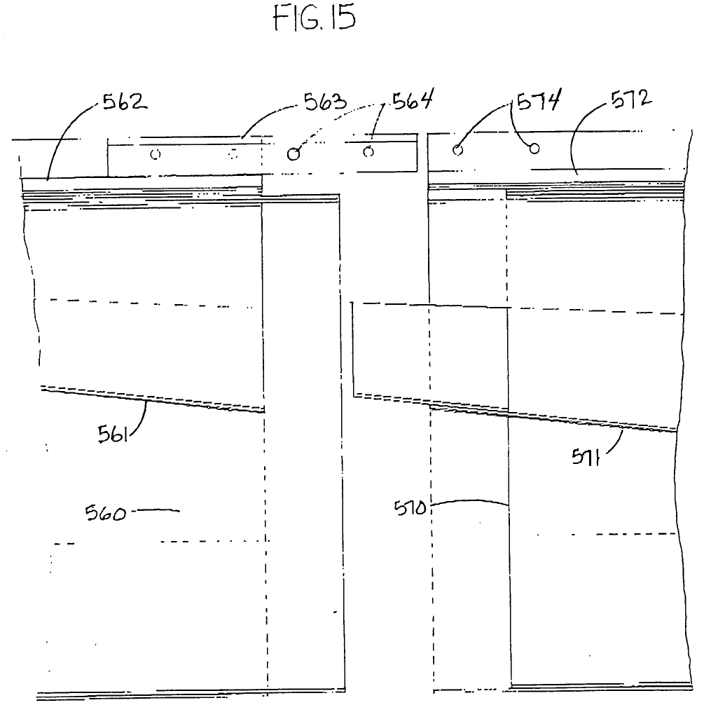

FIG. 13 is a top view of the distal end of an illumination tube, such as the tube shown in FIGS. 11 and 14 wherein a bracket 525 is connected to support 530 at the distal end of the illumination tube. FIGS. 11 to 13 illustrate that a plurality of brackets, e.g., brackets 525, can be utilized to support a single longer length of rigid support 530.

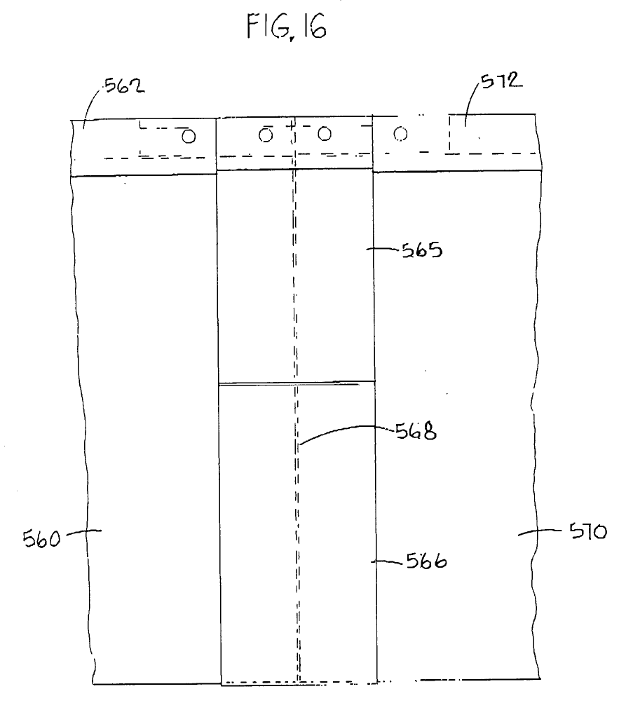

As mentioned above, it is also within the scope of the present invention to utilize the support and bracket system to join a plurality of illumination tube segments. FIG. 15 illustrates a first illumination tube segment 560 aligned for connection to a second illumination tube segment 570. The segments comprise reflective surfaces 561, 571, respectively, and supporting structure as illustrated in FIG. 8. According to this embodiment of the present invention, the support 562 of illumination tube segment 560 is designed to abut the support 572 of illumination tube segment 570 and bracket 563 is designed to overlap and be secured in position with pins or bolts extending through holes 564, 574. From the present description, it will be appreciated that the supports of these illustrated embodiments advantageously cover the longitudinal seams resulting from the formation of the illustrated illumination tubes from laminated sheets.

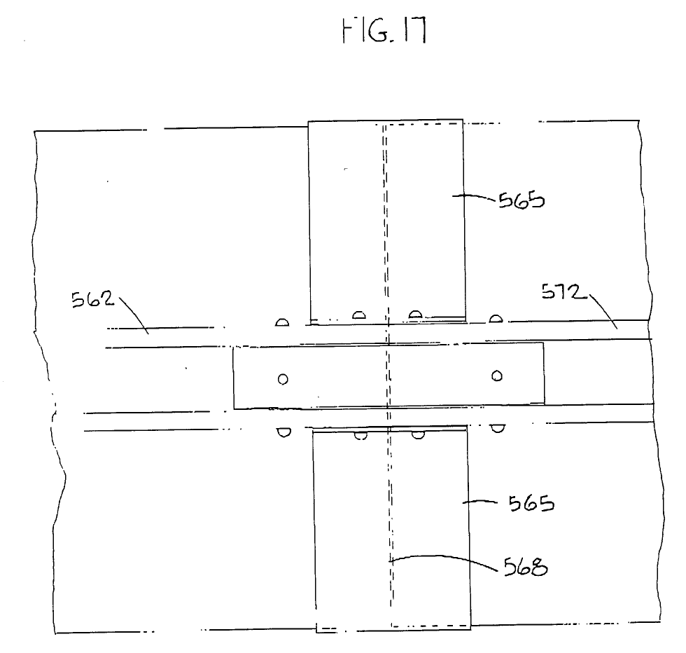

As best shown in FIGS. 16 and 17, in order to provide additional support to the circumferential seams formed by abutting illumination tube segments, this illustrated embodiment of the present invention is also provided with a partial circumferential support 565 connected to one or both of supports 562, 572. As best shown in FIG. 17, partial circumferential support 565 is connected to both supports 562 and 572 in order to secure the seam 568 formed by the adjoining segments 560, 570.

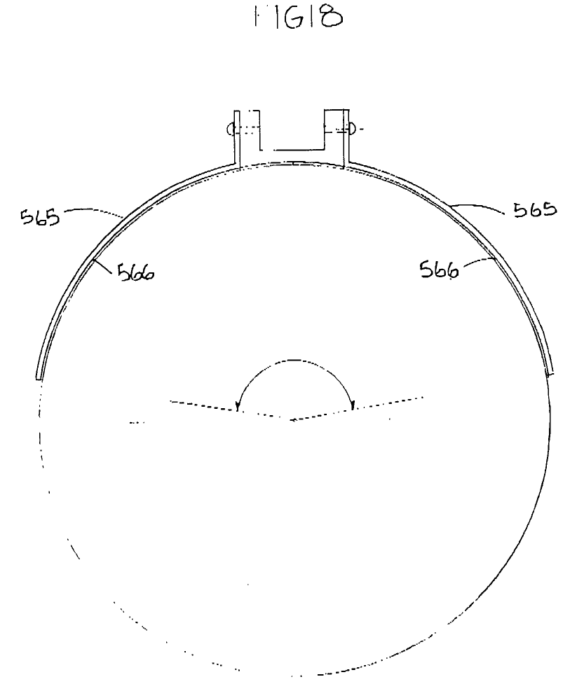

FIG. 18 is an end view also illustrating a partial circumferential support 565 which is between seams of illumination tube 569. As best shown in FIG. 14, partial circumferential supports 565 can be used on circumferential seams and at desired locations therebetween to provide support for the illumination tube. Partial circumferential support 565 can also be joined to the exterior of the illumination tube segments utilizing adhesive tape 566 such as VHB tape sold by The 3M Company of Minneapolis, Minn.

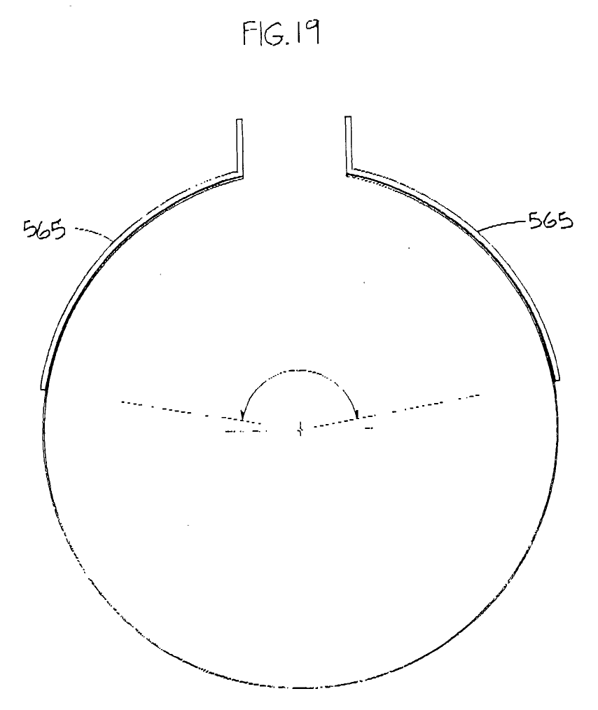

The preferred circumferential supports 565 advantageously serve as ribs by providing additional support for the illumination tube by extending partially around the circumference of the tube. As shown in FIG. 19, still further support can be provided by extending a strap 566 around the entire circumference of an illumination tube. Such a strap is preferably substantially clear to minimize blocking illuminating light. As shown in FIG. 19, a subassembly comprising two support ribs 565 can be connected to a clear strap 566 utilizing an adhesive tape 567. These subassemblies can be assembled long prior to installation of the illumination tube at its ultimate destination and can readily be wrapped around an illumination tube at the installation site for quick installation.

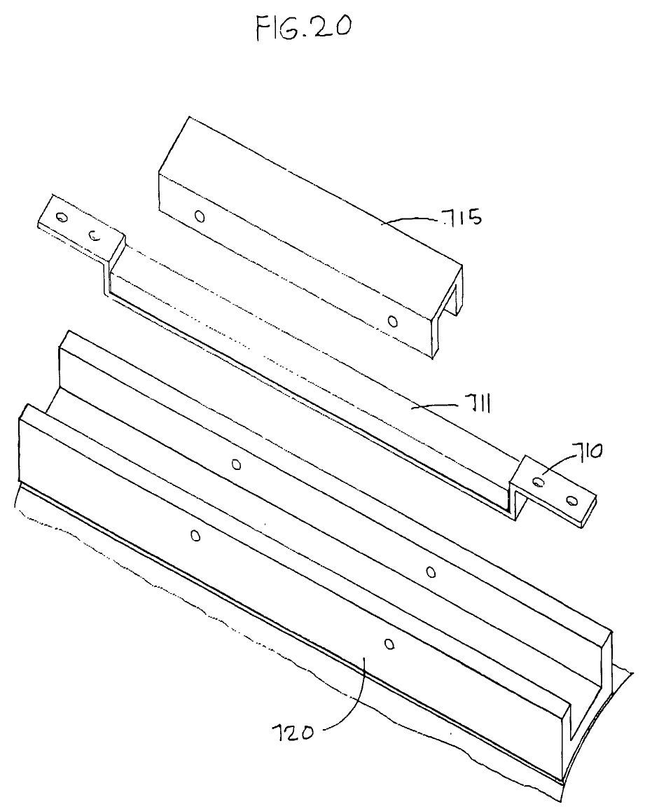

FIG. 20 is an exploded view of an alternative embodiment of the present invention wherein support 720 is movably connected to a bracket 710 utilizing a slidable connector 715. In this illustrated embodiment, bracket 710 is generally U-shaped and is preferably provided with a low friction surface such as nylon or teflon and secured to some structure in or proximate the area to be illuminated. In this illustrated embodiment, a nylon block 711 is positioned within the bottom of the U-channel of bracket 710. The slidable connector 715 is in the form of an inverted U according to this illustrated embodiment and is dimensioned to rest on and be movable in a longitudinal direction within the U-channel of bracket 710. The slidable connector 715 is connected to the support 720 with pins, bolts or the like passing into bores in support 720. When the slidable connector 715 is positioned over the nylon block 711 and connected to support 720, the support 720 and consequently the tube or tube segment attached to connector 720 are advantageously movable along the longitudinal axis in order to facilitate connection of tube segments or otherwise facilitate the installation or alignment of the illumination tube.

Another aspect of the present invention comprises the use of a coating, such as the SPRAYLAT™ coating described above on a non-smooth substrate such as the GE Lexan suede/matte film described above. Preferred coatings have a reflectance of greater than 95%, preferably greater than 97%. The non-smooth surface of the substrate preferably has bumps or ridges or other protrusions or indentations in the range of about 2 to 5 mils.

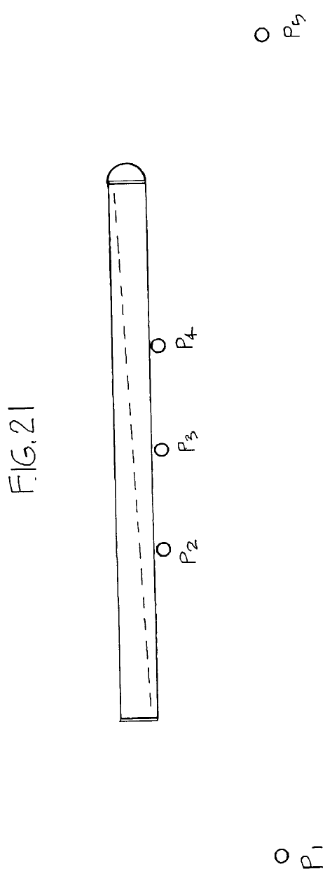

FIG. 21 illustrates points where light measurements were taken using a Minolta illuminance meter T-1 light meter in order to compare the intensity and field of illumination provided by two different illumination tubes. The first distributor tube utilized a light redirecting surface comprising SPRAYLAT™ white coating on a GE suede substrate while the second tube comprised a laminate of a 3M 3635-100 light enhancing film laminated to a GE suede substrate. Both illumination tubes utilized a Ushio 150 watt short arc lamp and all meter readings are in foot candles. The following table indicates the meter readings obtained from the first tube and the second tube at points P1-P5. The illustrated light distributing tubes used in this example were seven feet long. Reading point P1 was 22 inches beyond the distal end of the tube and 18 inches below the bottom surface of the tube. Point P3 was located at the bottom of the tube and at the middle of the tube while Points P2 and P4 were each offset 16 inches from Point P3. Point PS was 22 inches from the proximal end of the tube and 18 inches below the bottom surface of the tube.

| FIRST TUBE WITH | | SECOND TUBE WITH | |
|---|---|---|---|
| SPRAYLAT ™ COATED SUBSTRATE | | LAMINATED SUBSTRATE | |
| P1 | 75 | P1 | 140 |
| P2 | 1250 | P2 | 1100 |
| P3 | 1350 | P3 | 1000 |
| P4 | 1850 | P4 | 1280 |
| P5 | 39 | P5 | 30 |

These meter readings indicate that in the first illumination tube substantially more light is directed out in the desired areas of points P2-P4 and less projectory light is directed toward point P1. From these readings, it is believed that a coating having thickness of at least about 0.5 mils, preferably at least about 1.5 mils, and most preferably at least about 2 mils provides a reflective surface while not acting to effectively smooth out the bumps or ridges on the non-smooth surface of the underlying suede film.

1. An illumination device comprising:
a source of illumination;
a first substantially parabolic reflector comprising a first focal point, said first focal point positioned proximate said source of illumination; and
a second substantially parabolic reflector comprising a second focal point, said second focal point positioned proximate said source of illumination.

2. An illumination device according to claim 1 wherein said first reflector and said second reflector reflect light from said source of illumination in substantially the same direction and substantially parallel to a common axis.

3. An illumination device according to claim 2 further comprising an elongated light scattering surface which redirects light reflected by at least one of said reflectors.

4. An illumination device according to claim 3 wherein said first reflector and said second reflector direct a substantially focused beam of light along said common axis.

5. An illumination device according to claim 2 wherein said second reflector is positioned to reflect light from said source of illumination that would not be reflected by said first reflector in the absence of said second reflector.

6. An illumination device according to claim 4 wherein said light reflected by said reflectors comprises a beam spread of not greater than about 6°.

7. An illumination device according to claim 6 wherein said light scattering surface intercepts said light at an angle of not greater than about 30 to said longitudinal axis.

8. An illumination device according to claim 2 further comprising means for redirecting light reflected by at least one of said reflectors.

9. An illumination device according to claim 8 wherein said light redirecting means comprises a substrate and a light scattering coating.

10. An illumination device according to claim 9 wherein said substrate comprises a non-smooth surface.

11. An illumination device according to claim 1 further comprising an elongated light scattering surface which redirects light reflected by at least one of said reflectors.

12. An illumination device according to claim 1 wherein said second reflector has a focal length which is less than the focal length of said first reflector.

13. An illumination device according to claim 1 wherein said second reflector is connected to said first reflector.

14. An illumination device according to claim 1 wherein said second reflector is connected to said first reflector proximate the portion of the first reflector furthest from said source of illumination.

15. An illumination device according to claim 1 further comprising a light scattering surface which redirects light reflected by at least one of said reflectors, and a third reflector positioned on a side of said source of illumination opposite said light scattering surface.

16. An illumination device according to claim 15 wherein said third reflector reflects light, emanating from the focal point of said second reflector, away from said second reflector.

17. An illumination device according to claim 16 wherein said third reflector also reflects light, emanating from the focal point of said second reflector, away from said source of illumination.

18. An illumination device according to claim 1 further comprising an illumination tube which receives light reflected by said first reflector and said second reflector.

19. An illumination device according to claim 18 wherein said first focal point and said second focal point are substantially coincident.

20. An illumination device according to claim 1 wherein said first focal point and said second focal point are substantially coincident.

21. An illumination device according to claim 20 further comprising an illumination tube which receives light reflected by said first reflector and said second reflector.

22. An illumination device according to claim 1 wherein said first focal point and said second focal point are not spaced from each other by a distance greater than one-half the arc length of said source of illumination.

23. An illumination device according to claim 1 wherein said first focal point and said second focal point are not spaced from each other by a distance greater than the arc length of said source of illumination.

24. An illumination device comprising:
a source of illumination;
a first substantially parabolic reflector comprising a first focal point, said first focal point positioned proximate said source of illumination;
a second substantially conical reflective surface; and
a third reflector which reflects light emanating from said source of illumination onto said substantially conical reflective surface.

25. An illumination device according to claim 24 further comprising an illumination tube which redirects light reflected by at least one of said reflectors.

26. An illumination device according to claim 25 wherein said first reflector and said second reflective surface direct a substantially focused beam of light along a substantially common axis.

27. A illumination device according to claim 25 wherein said conical reflective surface is truncated.

28. An illumination device according to claim 27 comprising an opening for the passage of light at said truncated portion.

29. An illumination device according to claim 25 wherein said conical reflective surface tapers to a point.

30. A lighting tube comprising:
a light redirecting surface comprising a non-smooth substrate which is at least partially coated with a light scattering coating.

31. An illumination tube comprising:
a coated interior surface comprising a coating comprising an ultra violet light inhibitor.

32. An illumination tube according to claim 31 wherein said coated interior surface extends substantially the full length of said illumination tube.

33. An illumination tube comprising:
a tubular wall defining an elongated internal column;
an elongated support connected to an exterior surface of said light tube; and
at least one bracket releasably connected to said support.

34. An illumination tube according to claim 33 further comprising means for attaching said bracket to a structure.

35. An illumination tube according to claim 34 wherein said support if substantially rigid.

36. An illumination tube according to claim 35 wherein said support extends a major portion of the length of said light tube.

37. An illumination tube according to claim 33 wherein said support extends at least substantially the length of said light tube.

38. An illumination tube according to claim 33 wherein said support is connected to both sides of at least one longitudinal seam of said light tube.

39. An illumination tube according to claim 33 comprising a support extending at least partially around the circumference of said illumination tube.

40. An illumination tube according to claim 39 comprising a plurality of said at least partial circumferential supports.

41. An illumination tube according to claim 39 wherein said circumferential support extends around at least 1200 of said illumination tube.

42. An illumination tube according to claim 39 wherein said circumferential support extends around at least 1500 of said illumination tube.

43. An illumination tube according to claim 33 wherein said bracket is movably connected to said support.

44. An illumination tube according to claim 43 further comprising a slideable connector for connecting said support to said bracket.

45. An illumination tube according to claim 44 wherein said slidable connector is movable relative to said bracket and is connected to said support.

46. An illumination tube according to claim 44 wherein said slidable connector comprises a low friction surface.

47. An illumination tube according to claim 46 wherein said low friction surface comprises Teflon.

48. An illumination tube according to claim 46 wherein said low friction surface comprises nylon.

48. An illumination tube according to claim 46 wherein said low friction surface comprises a plurality of elements.

50. An illumination tube according to claim 33 comprising a plurality of said brackets.

51. An illumination tube according to claim 33 wherein said illumination tube comprised a curved exterior surface.

52. An illumination tube according to claim 51 wherein said support comprises a curved surface.
